(19) United States
(12) Patent Application Publication
(10) Pub. No.: US 2024/0169405 A1
(43) Pub. Date: May 23, 2024

(54) PEER-BASED AUDITING SYSTEM AND METHOD

(71) Applicant: NOVADATA SOLUTIONS LLC, Haverford, PA (US)

(72) Inventors: Anthony Troy, Haverford, PA (US); Chris Troy, Flourtown, PA (US); Chris Dixon, Merion Station, PA (US); Nathan Goodell, Frisco, TX (US)

(21) Appl. No.: 18/517,137

(22) Filed: Nov. 22, 2023

Related U.S. Application Data
(60) Provisional application No. 63/384,801, filed on Nov. 23, 2022.

(51) Int. Cl. G06Q 30/04

(52) U.S. Cl. CPC G06Q 30/04

(57) ABSTRACT

A computer-implemented method for peer-based invoice auditing is described. The computer-implemented method includes the steps of generating a first plurality of rate data by scraping rate data from a first invoice, first classifying the first plurality of rate data based on identifying rate data types in the first plurality of rate data, first populating a plurality of rate tables with the first plurality of rate data based on the rate data types in the first plurality of rate data, wherein each of the plurality of rate tables are populated with rate data from previously scraped invoices and each of the plurality of rate tables tracks a different type of rate data, first auditing the invoice based on comparing a plurality of values generated from data in each of the plurality of rate tables, and generating first audit result data based on the first auditing.

### CROSS-REFERENCE TO RELATED APPLICATIONS

This application claims priority to U.S. Provisional Patent Application No. 63/384,801 filed on Nov. 23, 2023, the contents of which are hereby incorporated by reference herein in their entirety.

### BACKGROUND OF THE INVENTION

In the restoration industry, insurance companies and insured companies experience significant financial losses due to inaccuracies with restoration bills. Losses are estimated between 8-15% of individual claims translating to approximately $1.9B across the industry.

The insurance industry does not have a neutral, independent entity that provides a platform for auditing bills, processes for certifications and claim/loss data for analysis. A platform as described has the potential to drive down costs, fraud exposure and turn-around times in the restoration industry by streamlining complex billing submission, reconciliation and remediation processes between restoration companies, independent adjusters, insurance providers and insured companies.

While the exact process used by various insurance companies to audit restoration bills may vary, industry wide the process has general overlap that leads to inefficient and sometimes unreliable auding. First, insurance companies typically require detailed documentation of the restoration work performed. This includes itemized invoices, receipts, and supporting documentation for materials and labor. This documentation is provided in various formats in both digital and hardcopy form depending on for example which contractor or entity is providing the documentation. Insurance adjusters then start their review of the documentation submitted by the restoration contractor to ensure that the work performed aligns with the terms of the insurance policy and is reasonable and necessary. While insurance often includes a comparative analysis to ensure that the costs charged by the restoration contractor are in line with industry standards and reasonable for the scope of work performed, the analysis is often manual and performed in a vacuum. Then, depending on the outcome of this review, rounds of communication between the insurance company and the restoration contractor will take place. Discrepancies about the billed amount are addressed in a process that is very time consuming and based on calculations for fees that the insurance company and the restoration contractor are at odds about, often requiring several additional hours of work to justify and often ending with settling on a number that is unfair or amounting to a loss.

Similar disadvantages exist beyond the restoration industry. For example, more generally in the insurance industry, when any loss occurs, a property owner files a claim with the insurance company. The insurance company often requests the help of an adjustment firm to audit and then negotiate the bill. Insurance companies sometimes rely on in-house adjusting teams for review. For property owners, when a loss falls under an insurance deductible or if a property owner is self-insured, the property owner may be responsible for and have a need to audit a restoration bill. In another example, when a loss occurs, a claim preparation group within a brokerage or an independent claim preparation company is often asked to audit a restoration bill prior to submitting it to the insurance company as a claim. Still further, from the perspective of restoration companies, when a restoration invoice is being prepared to send to the property owner, a billing analyst is responsible to self-audit the invoice to ensure it aligns with corporate standards and client contract terms.

A novel audit platform can provide a better process for handling invoices in a more reliable and accurate fashion while also processing the invoices more quickly, providing a large benefit for all participants involved. Substantial loses in both time and money can be minimized. Accordingly, there is the need in the art for an auditing platform that automates auditing, improves processes for certification, analyzes claim/loss data to provide reliable information to the industry, and reduces financial losses. Embodiments of the disclosed invention address this need.

### SUMMARY OF THE INVENTION

In one embodiment, a computer-implemented method for peer-based remediation invoice auditing is described. The computer-implemented method includes the steps of generating a first plurality of rate data by scraping rate data from a first invoice; first classifying the first plurality of rate data based on identifying rate data types in the first plurality of rate data; first populating a plurality of rate tables with the first plurality of rate data based on the rate data types in the first plurality of rate data, wherein each of the plurality of rate tables are populated with rate data from previously scraped invoices and each of the plurality of rate tables tracks a different type of rate data; first auditing the invoice based on comparing a plurality of values generated from data in each of the plurality of rate tables; and generating first audit result data based on the first auditing. In one embodiment, the plurality of rate tables comprises at least one of a labor rate table, an equipment rate table and a materials rate table. In one embodiment, the method includes second generating a second plurality of rate data by scraping rate data from a second invoice; second classifying the second plurality of rate data based on identifying rate data types in the second plurality of rate data; second populating the plurality of rate tables with the second plurality of rate data based on the rate data types in the second plurality of rate data; and second auditing the second invoice based on second comparing a second plurality of values generated from second data in each of the plurality of rate tables, the second data including the rate data from previously scraped invoices and the first plurality of rate data from the first invoice; and generating second audit result data based on the second auditing. In one embodiment, the second data includes rate data from a third invoice scraped after the first auditing and before the second auditing. In one embodiment, the first audit result data is further based on at least one rule variable updated in real time. In one embodiment, the computer-implemented method includes generating a benchmark audit of the first audit result and flagging the first audit if the benchmark audit is above a benchmark threshold. In one embodiment, the benchmark threshold value is based on at least one of invoice total, total amount of issues, total amount of labor issues, total amount of equipment issues and total amount of material issues.

In one embodiment, a system for peer-based remediation invoice auditing includes a computer comprising a storage device having a database management system; and computer-readable program code including steps for: generating a first plurality of rate data by scraping rate data from a first invoice, first classifying the first plurality of rate data based on identifying rate data types in the first plurality of rate data, first populating a plurality of rate tables with the first plurality of rate data based on the rate data types in the first plurality of rate data, wherein each of the plurality of rate tables are populated with rate data from previously scraped invoices and each of the plurality of rate tables tracks a different type of rate data, auditing the invoice based on comparing a plurality of values generated from data in each of the plurality of rate tables, and generating first audit result data based on the auditing. In one embodiment, the plurality of rate tables comprises at least one of a labor rate table, an equipment rate table and a materials rate table. In one embodiment, the computer-readable program code further includes steps for: second generating a second plurality of rate data by scraping rate data from a second invoice; second classifying the second plurality of rate data based on identifying rate data types in the second plurality of rate data; second populating the plurality of rate tables with the second plurality of rate data based on the rate data types in the second plurality of rate data; second auditing the second invoice based on second comparing a second plurality of values generated from second data in each of the plurality of rate tables, the second data including the rate data from previously scraped invoices and the first plurality of rate data from the first invoice; and generating second audit result data based on the second auditing. In one embodiment, the second data includes rate data from a third invoice scraped after the first auditing and before the second auditing. In one embodiment, the first audit result data is further based on at least one rule variable updated in real time. In one embodiment, the computer-readable program code further includes steps for: generating a benchmark audit of the first audit result and flagging the first audit if the benchmark audit is above a benchmark threshold. In one embodiment, the benchmark threshold value is based on at least one of invoice total, total amount of issues, total amount of labor issues, total amount of equipment issues and total amount of material issues. In one embodiment, the plurality of rate tables comprises at least one of a labor rate table, an equipment rate table and a materials rate table. In one embodiment, the computer-readable program code further includes steps for: second generating a second plurality of rate data by scraping rate data from a second invoice; second populating a plurality of rate tables with the second plurality of rate data; second auditing the second invoice based on second comparing a second plurality of values generated from second data in each of the plurality of rate tables, the second data including the rate data from previously scraped invoices and the first plurality of rate data from the first invoice; and generating second audit result data based on the second auditing. In one embodiment, the second data includes rate data from a third invoice scraped after the first auditing and before the second auditing. In one embodiment, the first audit result data is further based on at least one rule variable updated in real time.

In one embodiment, a computer-implemented method for auditing restoration bills includes the steps of scraping uploaded billing data and characterizing the billing data based on a set of predetermined billing data scraping rules; and flagging the characterized billing data based on a set of flagging rules, wherein the flagging rules include at least one rule variable updated in real time. In one embodiment, the method includes the steps of generating an authentication step based on the characterized billing data. In one embodiment, the method includes the steps of generating a service provider confidence score based on the flagging.

In one embodiment, a system for auditing restoration bills includes a computing device hosting a software and a database; where the software includes automated features for uploading and categorizing billing data, the database contains billing data and rules for categorizing billing data, and the user interface allows interaction with software and data.

In one embodiment, a computer-implemented method for auditing restoration bills includes scraping billing documents for relevant billing data; categorizing the billing data based on a set of rules in a database; and providing the relevant billing data to a user via a user interface.

In one embodiment, a system for authenticating a bill interaction portal, includes a computing device hosting a software and a database, a secure token for service provider identity verification, and an interface for verified direct communication between more than one user in the portal.

In one embodiment, a computer-implemented method for authenticating a bill interaction portal includes the steps of providing a secure token to a user, providing a user interface for a bill interaction portal, and establishing a verified direct communication between more than one user.

In one embodiment, a system for generating a service provider confidence score, includes a computing device hosting a software and a database; a unique service provider identification number; and a confidence score for the service provider calculated from the service provider metrics stored in the database. In one embodiment, the service provider metrics are chosen from the group consisting of: previous rating, previous bills, a risk assessment score, willingness of the service provider to be audited, the presence of a rate sheet.

In one embodiment, a computer-implemented method for generating service provider confidence score includes the steps of providing a unique service provider identifier for each service provider, and calculating a confidence score based on service provider metrics.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIGS. 1A and 1B are diagrams of a computing system and environment according to one embodiment, and FIG. 1C is a diagram of an exemplary process flow according to one embodiment.

FIG. 2 is a diagram of a peer-based auditing system according to one embodiment.

FIG. 3 is a flow chart of a peer-based auditing method according to one embodiment.

FIG. 4 shows a diagram of a secure “no-login” auditor to restoration co. communication and negotiating service according to one embodiment.

FIG. 5 shows a flowchart of an exemplary method for auditing restoration bills according to one embodiment.

FIG. 6 shows a flowchart of an exemplary method for authenticating a bill interaction portal according to one embodiment.

FIG. 7 shown is a flowchart of an exemplary method for generating service provider confidence score according to one embodiment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, and +0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Embodiments of the system reduce financial leakage (est. 8-12%). Leakages are automatically identified, summarized and ready for approval. An increase in issues identified is another advantage, as the systems engine consistently finds issues that are challenging to find manually. Embodiments of the system leverage industry comparisons, providing clarity that bills compare well to prior bills across a geography, industry and/or event. Embodiments of the system leverage historical analysis. Bills are stored and leveraged to compare current bills against prior similar bills. Embodiments of the system provide unbiased reviews utilizing rules execute the same for all bills, removing any potential for a biased review. Embodiments of the system reduce calendar time (est. 50% reduction), as audits execute immediately, so bills won't sit on a desk for weeks. Embodiments of the system increase confidence of carriers to pay quickly, as bills are automatically scanned for key rates, ratios and reasonability every time. Embodiments of the system reduce exposure by clearing cases quicker. The longer a case is open, the more exposure a carrier has, so closing quickly and confidently is critical to improving customer satisfaction by paying quicker. Carriers that pay valid claims quickly have a much higher chance for retention. Embodiments of the system reduce IA review time (est. 50% reduction). The system saves IA costs and time by completing tasks in minutes that currently requires at least hours or days. Embodiments of the system leverage automation to dissect bills/flag issues. It provides clarity that bills compare well to prior bills across geography, industry and events. Embodiments of the system reduce adjuster effort and delays. The system's workflow reduces the time it takes adjusters to work with restoration companies. Embodiments of the system increase accuracy of audits. The audit function integrates checks and balances to ensure accuracy.

In one embodiment, an auto invoice detection system and method utilizes auto-identification and fingerprinting of restoration invoices for automated auditing. In one embodiment, a peer-based rate audit system and method are implemented, automating metrics for peer-based labor, equipment and material rate auditing. In one embodiment, a configurable industry benchmark rate/ratio audit system and method are implemented, deploying a user controlled/parameter-based invoice audit engine with baseline industry benchmark ratios. In one embodiment, audit of audits service system and method are implemented, using a parameter based automated engine that also learns reasonable ranges of an acceptable audit. Additional methods such as an automated restoration invoice audit workflow, a secure “no-login” negotiating and communication service, and a secure “no-login” confirm invoice audit receipt methodology are described herein.

A system and method for auditing restoration bills is disclosed in several embodiments. In one embodiment, the system implements and method includes the steps of scraping billing data and characterizing the billing data based on a set of predetermined billing data scraping rules, and flagging the characterized billing data based on a set of flagging rules, wherein the flagging rules include at least one rule variable updated in real time. The system and method can generate an authentication step based on the characterized billing data. The method can generate a service provider confidence score based on the flagging.

In one embodiment, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In one embodiment, elements of the networked portion of the invention may be implemented over a Virtual Private Network (VPN).

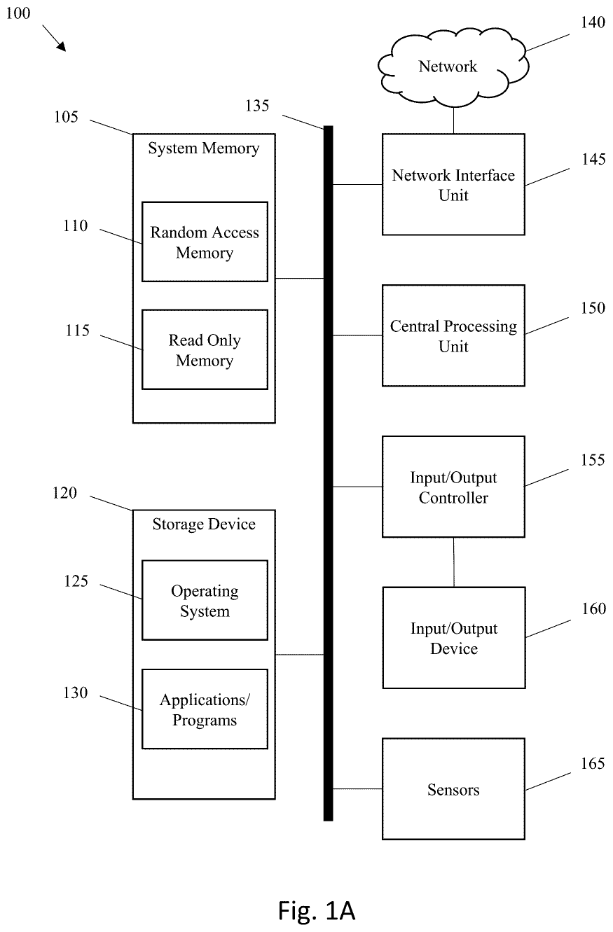

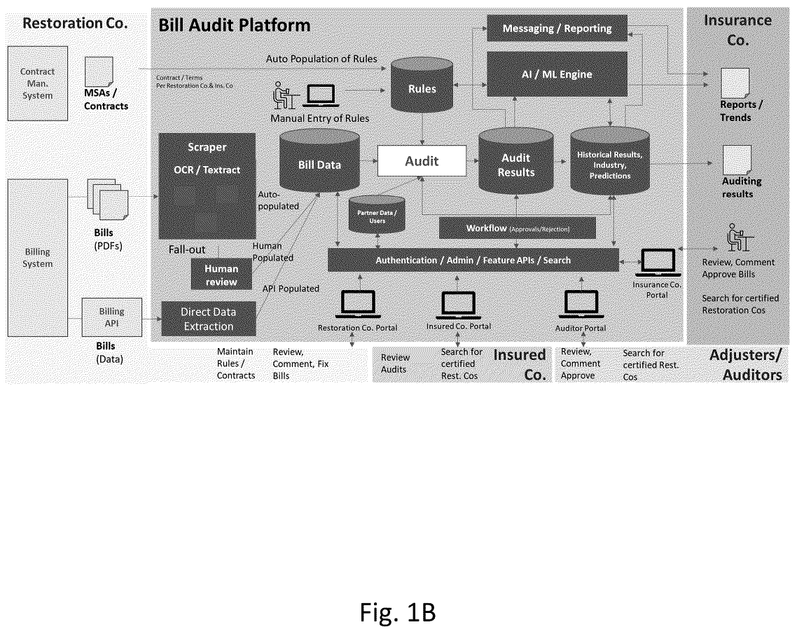

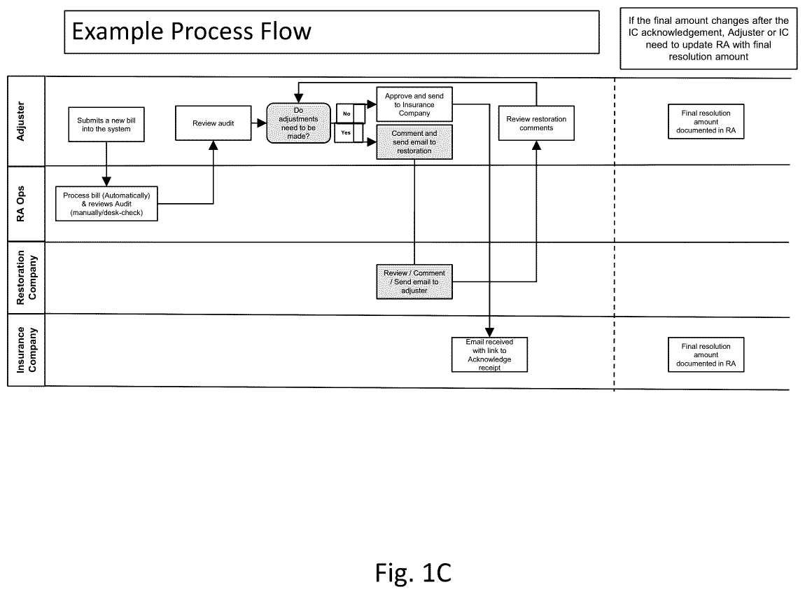

FIGS. 1A, 1B and the following discussion provide a description of a suitable computing environment in which the invention may be implemented according to one embodiment. While embodiments of the invention are described in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The computer architecture shown in FIG. 1A illustrates according to one embodiment a conventional personal computer, including a central processing unit 150 (“CPU”), a system memory105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

One or more computers are implemented into embodiments of the system as shown for example in FIG. 1B for providing functionality of the various modules. A bill audit platform may for example including a scraper or extraction module that receives bill data and implements text recognition software such as OCR for categorizing billed amounts and types. A bill data database can store the data in tables based on the data type. Authentication features can be implemented in a separate module that protects access to the system for authorized users only, while also providing streamlined authentication features as explained in further detail below. A rule database can also be implemented to store various rules, such as thresholds that are flagged when exceeded. Messaging functionality is integrated into the system for managing for example communication between the auditing platform and restoration companies, and the auditing platform and insurance providers.

By way of example, and not to be limiting, computer-readable media of the bill audit platform may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 and bill audit platform may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 and bill audit platform may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above and shown for example in FIGS. 1A and 1B, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in one embodiment can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Aspects of the invention relate to a machine learning algorithm, machine learning engine, machine learning model, or neural network. In various embodiments, the machine learning engine may include supervised, unsupervised, and semi-supervised learning. In the case of supervised learning, algorithms may include nearest neighbor, naïve bayes, decision trees, support vector machines, and neural networks. In various embodiments, models may be trained by updating parameters based on various attributes of an insurance software system, for example service provider and vendor attributes, or billing data, and may output a one or more reports (e.g., audit reports) or confidence scores based on the attributes. In various embodiments, the supervised or semi-supervised model may be updated with hyperparameters for a deep learning model. In a preferred embodiment, a neural network may be trained by updating parameters based on various attributes of an insurance software system, for example restoration company billing data, and may output a service provider confidence score based on the attributes.

In one embodiment, attributes may include service provider confidence score, vendor attributes, billing attributes, management to staff ratio, overtime ratio, lunch time audit, travel time audit, mark-up audit (e.g., reimbursables, labor, etc), equipment term discount, labor, equipment, & material adherence (based on peer-to-peer pricing), billing data, previous service provider rating, restoration insurance data, restoration company billing data, OCR data, text data, or image data. The resulting audit results or vendor profile may then be judged according to one or more binary classifiers or quality metrics, and the weights of the attributes may be optimized to maximize the average binary classifiers or quality metrics. In this manner, a neural network can be trained to predict and optimize for any binary classifier or quality metric that can be experimentally measured. Examples of binary classifiers or quality metrics that a neural network can be trained on include audit results, vendor attributes, per diem cost, equipment term discount, time & material costs, labor rate, labor rate or rate range, industry role rate or rate range, and any other suitable type of metric that can be measured. In one embodiment, the neural network may have multi-task functionality and allow for simultaneous prediction and optimization of multiple quality metrics.

In embodiments that implement supervised or semi-supervised models, such as a neural network, a query may be performed in various ways. A query may request the neural network identify a vendor attribute to increase a desirable parameter, for example service provider confidence score, vendor attributes, or vendor rating. A supervised or semi-supervised learning model of the present invention may identify one or more vendor profiles whose predicted labor rate range (as evaluated by the neural network) exceeds a labor rate table, thereby indicating that the vendor requires an alert in the system. As contemplated herein, a predicted vendor attribute may be any of labor costs, material costs, job costs, location, staff required, man per job, time to complete job, or service provider confidence score.

In one embodiment, the supervised or semi-supervised learning model may be updated by training the model using a value of the desirable parameter associated with an input restoration insurance bill. In the case of the neural network, this may be referred to as the input layer. Updating the model in this manner may improve the ability of the model in proposing optimal audits, reports, results, confidence scores, or questionnaires. In the case of the neural network, this may be referred to as the output layer. In one embodiment, training the model may include using a value of the desirable parameter associated with a high service provider score or desirable vendor attribute. For example, in one embodiment, training the model may include predicting a value of the desirable parameter for the proposed cost of time & material, comparing the predicted value to the corresponding value associated with a known cost of time & material, and training the model based on a result of the comparison. If the predicted value is the same or substantially similar to the observed value, then the neural network may be minimally updated or not updated at all. If the predicted value differs from that of the known cost of time & material, then the model may be substantially updated to better correct for this discrepancy. Regardless of how the model is retrained, the retrained model may be used to select vendor profiles or propose values for cost of time & material.

Although the techniques of the present application are in the context of optimizing restoration insurance and providing value to restoration companies, insurance companies, and the insured, it should be appreciated that this is a non-limiting application of these techniques as they can be applied to other types of parameters or attributes, for example other insurance software systems. In one embodiment, the system can be implemented for the self-insured, or property owners that do not meet their deductible, as they could leverage the system to help bring down restoration costs. In one embodiment, the system can be implemented for brokers for their property owner clients. In one embodiment, the system may audit restoration “build-back” invoices (e.g. work done to restore a property to its pre-loss condition once all mitigation work has been completed). In one embodiment, the system may evaluate competing bids for the selection of a restoration company for the “build back” portion of the restoration of a building. In one embodiment, the system may perform historical “clawback” audits on previously paid restoration invoices. In one embodiment, the system may for example audit roofing repair invoices and new construction invoices. Embodiments of the system can be implemented more broadly, applicable to various areas of insurance or billing such as health insurance bills, auto insurance claims and the like.

Depending on the type of data used to train the model, the neural network can be optimized for different types of insurance and commercial applications. In this manner, a neural network can be trained to provide optimized scores, rates and vendor attributes based on more than one industry. Querying the model may include inputting an initial service provider, insured individual, or vendor attribute. The model may have been previously trained using different insurance software systems, databases, logs, records, or the like. The query to the model may be for a region or state. An audit report may be received from the model in response to the query.

The techniques described herein associated with iteratively querying a model by inputting billing data, receiving an output from the model that has scores, reports, or the like, and successively providing scores, reports, or the like, as an input to the model, can be applied to other machine learning applications. Such techniques may be particularly useful in applications where a final output having specific score, or labor and material rate is desired. Such techniques can be generalized for identifying a series of discrete attributes by applying a model generated by a model trained using data relating the discrete attributes to a characteristic of a series of the discrete attributes. In the context of billing data, the discrete attributes may include key details (e.g., construction type, occupancy type, square footage/volume, average size of apartments in multi-unit residential, number of stories, number of stores affected, average ceiling height, floor coverings, interior wall finishes, HVAC system, age of building, most recent renovation, moisture readings, building condition), and/or any other measurable quantity contained in the billing data.

In one embodiment, an iterative process or parameter updating is formed by querying the model for an audit report, receiving the audit report, and identifying a vendor trend or vendor region. An additional iteration of the iterative process may include inputting the audit report from an immediately prior iteration. The iterative process may stop when a vendor profile matches a prior audit report from the immediately prior iteration. In the case of the neural network, the parameters are updated for the hidden layer, where the hidden layer is positioned between the input and output layers discussed above. The hidden layer of the neural network may include any number of layers or depth. Each of the layers may be associated with a number of nodes or width.

In one embodiment, an automated insurance platform provides data scraping and auditing capabilities. This platform establishes a network of restoration industry partners and provides them with a shared platform of simple and effective tools to communicate, audit, analyze, remediate and “certify” bills. With the established network, a rich set of claim and loss data may be available in a repository. Machine Learning and Artificial Intelligence models are leveraged to identify patterns/recommendations for key domains including underwriting.

Certain aspects of the present invention relate to a software platform operating on a computing device or computer. The disclosed software platform may operate on computer 100 as described above or any suitable computing platform as would be known by someone having ordinary level of skill in the art.

The disclosed invention has the ability to provide insurance companies with reduced losses dues to billing waste/leakage, decreased time, cost and exposure by closing cases quickly, increased confidence in paying rigorously audited bills, increase access to Claim/Loss Data and Analysis, and decreased time in approving work for customer.

The disclosed invention has the ability to provide restoration companies with increased speed of bills getting paid, increased transparency with insurers and insured Cos., increased credibility & sales by marketing their participation in the platform, decreased resubmission numbers and cost, and increased confidence that bills match contracts.

The disclosed invention has the ability to provide independent/internal adjusters with decreased review/reconciling time, increased ability to effectively handle more projects, access to platform data (rates/bills) across industry, increased confidence in adherence to agreements by working with platform approved restoration companies, and increased effectiveness of finding mistakes/fraud.

The disclosed invention has the ability to provide Insured Companies with reduced Losses due to billing waste/leakage, decreased time and cost in reviewing bills, increased access to Claim/Loss Data and Analysis, and increased confidence in Restoration Co by using platform approved companies Increase confidence project will be done with high quality.

In some aspects, the present invention relates to a software platform for enabling unique service provider identification, service provider rating, automation of restoration insurance processes, and introducing a machine-learning based data-scraper and forensics algorithm

In some aspects, the present invention relates to the data sourced for the platform. In one embodiment, data for the platform may be sourced from, but not limited to, Master Service Agreements (MSA), Servicing Contracts, Restoration Bills.

In some aspects, the present invention relates to the processing functions applied to the sourced data. In one embodiment, Optical Character Recognition (OCR) is used as a method for scraping or extracting data from sourced data. In one embodiment, Intelligent Word Recognition (IWR) is used as a method for scraping data from sourced data. In one embodiment, Intelligent Character Recognition (ICR) is used as a method for scraping data from sourced data. In one embodiment, Optical Word Recognition (OWR) is used as a method for scraping data from sourced data. In one embodiment, Optical Mark Recognition (OMR) is used as a method for scraping data from sourced data. In one embodiment, any combination of OCR, IWR, ICR, WR and/or OMR is used as a method for processing sourced data. In one embodiment, a digital image processing is used as a method for scraping data from sourced data. For example, in one embodiment, an object recognition algorithm is used to scrape data from sourced data. In one embodiment, an object identification algorithm is used to scrape data from sourced data. In one embodiment, an object detection algorithm is used to scrape data from sourced data.

In some aspects, the present invention relates to a confidence score or rating and the use of this score within the software platform. In one embodiment, a confidence score is assigned based off of service provider metrics. In one embodiment, a confidence score is calculated based off of service provider metrics. In one embodiment, the service provider metrics may be, but not limited to, previous service provider bills, previous and/or current service provider rating, service provider willingness to be audited, presence of service provider rate sheet, service provider providing additional information to the platform. Although some examples of service provider metrics are provided, the metrics used in calculating the service provider confidence score may be any service provider related metric. For example, the length of the time the service provider has been in business, or in another example, the amount of data the service provider has provided to the software platform.

An example process flow is shown in FIG. 1C according to one embodiment. Adjuster submits a new bill into the system, and the system processes the bill with an automated audit review according to embodiments described herein. The adjuster reviews the audit and determines if any additional adjustments should be made. If yes, they can add comments and send an email of the audit with issues identified to the restoration company for their review. If no, they can approve the invoice and send directly to the insurance company.

In some aspects, the present invention relates to an Auto-Identification/Fingerprinting of Restoration Invoices for Automated Auditing. Through advanced profiling of a wide variety of restoration invoices, the platform has identified patterns that have resulted in clear fingerprints of invoice formats and the restoration companies that generated the invoices. This fingerprinting allows the platform to automatically identify specific types of invoices, detect specific datasets in the invoice (e.g. labor, equipment, materials), and leverages learned knowledge on how to normalize the data to allow for standard audits to be applied.

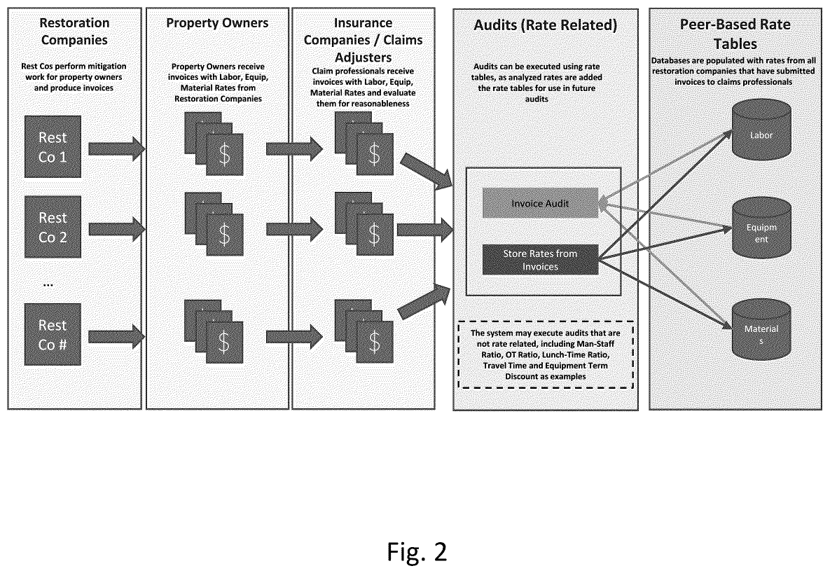

With reference now to FIG. 2, in some aspects, embodiments of the invention relate to an automated peer-based labor, equipment and material rate auditing. Property owners and insurance companies need to know if rates they are being asked to pay are reasonable. Embodiments of the platform determine reasonability of rates by scraping labor, equipment and material rates off of all invoices submitted to the platform, and storing them for reuse in audits. Since the invoices came from all major restoration companies, from all 50 states, and a variety of industries, the rate comparison acts as a peer review. The platform calculates a distribution of all rates received for each individual type of labor, equipment and materials then calculates benchmarks including quartiles, averages and percentiles. Audits leverage the peer-based rate data by evaluating new invoices against calculated benchmarks. One such benchmark is the top of the third quartile. In that case, any rate on an invoice being evaluated that falls above the top of the 3^{rd} quartile is considered to be “high as compared to peers”. Sensitivity analysis is automatically performed to normalize rate data across different geographies that may have varying wage indexes thus allowing the peer-based audit to be effective regardless of where the work related to the invoices was performed.

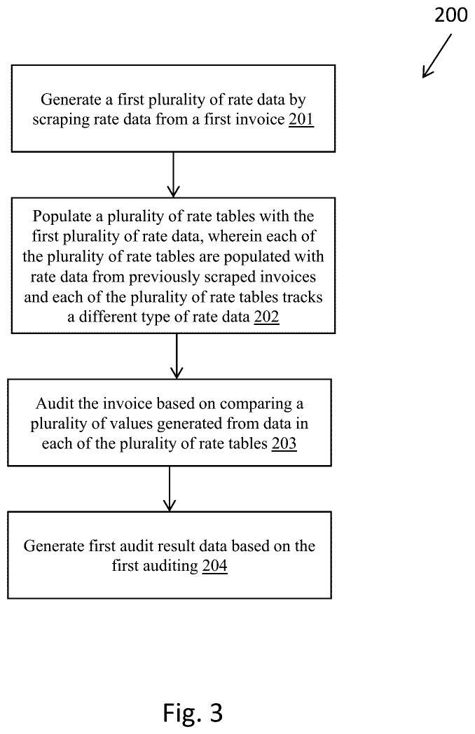

Referring now to FIG. 3, shown is a flowchart for an exemplary method 250 for auditing restoration bills according to one aspect of the present invention. In one embodiment, method 250 comprises the steps of 251 uploading billing data to a computing platform; 252 scraping the uploaded billing data and characterizing the billing data based on a set of predetermined billing data scraping rules; and 253 flagging the characterized billing data based on a set of flagging rules, wherein the flagging rules include at least one rule variable updated in real time. In one embodiment, method 250 further comprises the steps of 254 generating an authentication step based on the characterized billing data, and/or 255 generating a service provider confidence score based on the flagging.

Accordingly, in one embodiment, a computer-implemented method for peer-based remediation invoice auditing, includes the steps of generating rate data by scraping rate data from a first invoice, and populating rate tables with the rate data. Each of the rate tables are populated with rate data from previously scraped invoices. Bills can be scraped utilizing a bill type classifier that inspects all bills looking for fingerprints of distinct types of bills. It then sends bills to an OCR service & parsers that understand detailed characteristics of that bill type so it can be decomposed and audited. An OCR service/scraping tool selector leverages a series of scraping tools to determine the best method to decompose the bill. Some bill types are generated in a way that pose issues for some OCR tools but work fine with others. The OCR service learns which tool works best for each bill type and uses the appropriate tool. Intelligent parsers are implemented to grab specific data points from bills to load into a database for auditing. Each bill displays key data points (e.g. labor, equipment, material, dates, totals, subtotals) differently, and thus the parsers must be sufficient to recognize the nuances of the bill and load its data consistently for auditing.

Each of the rate tables can track a different type of rate data. The invoice is audited based on comparing the values generated from data in each of the rate tables and generating first audit result data based on the first auditing. Various methodologies can be utilized to determine whether data scraped from the bill is an outlier in comparison to data in the rate tables. For example, using Z-Score analysis, the system can calculate the Z-score for each invoice data point, representing how many standard deviations the invoice data point is from the mean. Values with high absolute Z-scores (e.g., greater than 2 or 3) may be considered outliers. Another methodology such as IQR (Interquartile Range) analysis can be used. The IQR can be calculated by finding the difference between the third quartile (Q3) and the first quartile (Q1). Invoice data points beyond Q1−1.5*IQR or Q3+1.5*IQR may be considered potential outliers. Statistical tests such as Grubbs' Test or Dixon's Q Test can be implemented. Grubbs' Test is a statistical test used to detect a single invoice outlier in a univariate dataset. It compares the sample mean to the potential invoice outlier to determine if it is significantly different. Dixon's Q Test is similar to Grubbs' test and is used to identify invoice outliers in a univariate dataset. It compares the difference between the maximum or minimum value and the second maximum or minimum. Machine learning techniques, which may include clustering algorithms (e.g. grouping similar invoice data points together and identifying invoice outliers as data points that do not belong to any cluster), or isolation forests (e.g. an anomaly detection algorithm that isolates invoice outliers by recursively partitioning the data. Distance-based methods for detecting outliers include Mahalanobis distance methods (e.g. measuring the distance between an invoice data point and the mean of a distribution, considering the correlation between variables and designating data points with high distances as outliers), and Euclidean distance methods (e.g. calculating the distance between invoice data points in a multidimensional space and designating data points with high distances as outliers). Other methods known in the art for identifying outlier data values in comparison to previously recorded data can be implemented. Different methods can be utilized for different types of data depending on the nature of the data. Some values that might be considered outliers in one context may be entirely valid or expected in another. A combination of methods can be used for a more robust outlier detection approach.

The rate tables may include at least one of a labor rate table, an equipment rate table and a materials rate table. The method can include the steps of generating a second set of rate data by scraping rate data from a second invoice, populating rate tables with the second set of rate data, and auditing the second invoice based on comparing a second set of values generated from data in each of the rate tables. The data can include the rate data from previously scraped invoices and the first set of rate data from the first invoice. This way, the data set improves for identifying outliers with each invoice that's scraped. So for example, the second set of data may include rate data from a third invoice scraped after the first audit but before the second audit. Other input may impact the audit updated in real time, such as factors that may reasonably impact restoration costs in real time, such as real time supply chain impacts, weather impacts, and the like. Regional input may for example take into account different locations having different labor costs, labor availability, and infrastructure or geographical limitations. Building type input may for example take into account structural differences (e.g. steel buildings may have different methods for restoration than wood buildings). The severity of weather impact is important (e.g. if a huge hurricane rolls through, restoration contractors may have to travel to the loss and incur more costs). Cause of loss input may for example factor in whether the cause of loss type, such as fire, hurricane or tornado. Industry type input may for example factor whether hospitals have different restoration requirements than schools, and for example special considerations for working in an environment in close proximity to a particular population, such as kids, patients or a particularized traffic area. In another example, if factors dictate that the response time for performing restoration work is longer than typical due to weather conditions or other factors, an auditing variable may be increased to allow for higher restoration cost and pass them though audit as reasonable. As slower response times can lead to additional damage and increased costs, the system can gather the relevant data regarding weather, traffic patterns, supplier availability, etc. to determine of the higher costs are justified. Other factors like the availability of skilled contractors and restoration professionals in real-time can affect labor costs. During peak seasons or after large-scale natural disasters, there may be a higher demand for contractors, potentially leading to increased labor costs. Material costs may also come into play. The prices of construction materials can fluctuate based on market conditions, supply and demand, and geopolitical factors. An auditing variable may for example monitor trends in supply costs available from online data, and adjust material supply audit rules accordingly. Adverse weather conditions as mentioned above can affect the restoration timeline and costs. Additional protective measures and extended construction and travel times lead to delays that may justify increased costs. Advantageously, embodiments of the system can account for local market conditions, including labor rates, local supply chains and local weather, all of which can impact restoration costs. The system may also identify conditions that are more ideal than normal, which can be expected to lower costs below typical costs and account for an expected cost savings. Embodiments of the system may also generate tables of data and execute audits for data points that are not rate related, including for example man-staff ratios, overtime ratios, lunch-time ratios, travel time and equipment term discounts as examples.

In some aspects, the present invention relates to a user controlled/parameter-based invoice audit engine with baseline industry benchmark ratios. The platform has a set of audits it performs beyond just the peer-based rate reviews. It calculates and evaluates many ratios against benchmarks, including management to staff, overtime, travel time, and lunchtime allowances. Considering the complexity and nuances of the types of buildings, industries, and event type (e.g. hurricane, tornado, mudslides) a single set of benchmarks is not sufficient for accurate evaluations. So the platform provides configurable benchmark overrides for the peer-based rate audits as well as the ratios. This allows experts to adjust the findings of the audit based on subjectivity regarding the intricacies of the loss and be appropriately tailored to the invoice and ultimately produce a fair evaluation.

Embodiments of the invention relate to a parameter-based automated engine that also learns reasonable ranges of an acceptable audit. Accuracy of the audit is critical to the platform. Considering that the platform's audit results are based on the success of PDF scraping technology (which can have issues depending on the quality of the document) and complex financial audits, it is critical that automation is used to quickly and accurately determine the reasonability of each audit. The platform executes a series of automated checks that first look for the completeness of the data scraped from the PDF. This is done by comparing the total dollars from the scraped data with the total amount of the invoice as entered manually by the operations analyst. If the totals are off by a configurable amount (currently 3%), then an alert is posted so that the audit can go through a detailed review. If it is below 3%, it is assumed to be a successful scrub. The next steps are to evaluate the overall errors identified in the audit as well as all key individual audits. The first check here is to determine what percentages of the entire invoice has issues. If the total amount is over 20% and below 50% the audit is placed in a medium severity alert queue. If the total is above 50% the audit is placed in a high severity alert queue. The same process is used for each ratio's issues as compared to the total line-item amount of the invoice related to that ratio (e.g. overtime). According to one embodiment, a graphical user interface can include slide bars to allow for easy viewing of auditing data results by customized thresholds.

Embodiments of a graphical user interface can for example include an audit summary by category screen according to one embodiment. The audit summary notes the total bill amount with the financial impact of issues found. The interface explains the financial impact of issues identified and breaks each line item into “Subcategories” of issues found. A detailed section allows for drilling into material audit issues, and “Days in Queue” are tracked so that alerts can be generated. Another embodiment may for example show an equipment term discount screen according to one embodiment. The term discount audit calculates the estimated weekly and monthly costs & savings for equipment used over 7 days. This module ensures that long-term equipment lease cost savings are properly accounted for and captured, and properly passed along in the invoice. Industry ratios can be applied to estimate weekly and monthly costs/savings. Calculated estimates were compared to totals and any equipment term discounts provided on the bill, and discrepancies were flagged. Another embodiment may for example show a management staff ratio check screen according to one embodiment. The management to staff ratio audit calculates a reasonable ratio between workers and supervisors and highlights overages including net savings. The system executes an audit using an industry standard ratio, calculates a reasonable management cost, and calculates a net savings. Another embodiment may for example show an audit issue search screen according to one embodiment. The audit issue search allows for freeform searching of the types of issues identified in the audit along with financial impact. The system allows for search by categories where issues were found, allows for search by description of bill line item, and allows sorting of top issues by financial impact. Another embodiment may for example show an audit monitoring screen according to one embodiment.

An audit of audit benchmarks is provided according to one embodiment. Audits that are generated will be evaluated automatically to determine of the audit appears to be in the realm of acceptability. Benchmarks include:

Invoice total—the first check is to see how close the total amount of the invoice that was scraped by the pdf is to the exact invoice amount typed in when the invoice was loaded. The system flags anything above a predetermined amount, e.g. anything above a 3% difference for a high priority review.

Total amount of issues—data has shown that a reasonable audit can find between 0-40% of the invoice amount has issues in one embodiment. If the audit results are above that, a high priority review can be considered.

Total amount of labor issues—data has shown that a reasonable audit can find between 0-40% of the labor amount has issues in one embodiment. If the audit results are above that a high priority review can be considered. This includes management-to-staff ratio and overtime ratio.

Total amount of equipment issues—data has shown that a reasonable audit can find between 0-40% of the equipment amount has issues according to one embodiment. If the audit results are above that, a high priority review can be considered.

Total amount of material issues—data has shown that a reasonable audit can find between 0-40% of the material amount has issues according to one embodiment. If the audit results are above that, a high priority review can be considered.

In one embodiment, an automated invoice audit & approval workflow is provided. The process to evaluate an invoice has many steps, some automated and some require human interaction. Therefore, a robust and easy to visualize workflow is necessary to navigate the invoice from beginning to end and help users understand the state of the audit. The workflow is initiated when an invoice is loaded onto the platform, at this point it is in a draft state. If the PDF scraping and financial audits are successfully executed, it is marked as successful scrub. If they fail for some technical reason, it is marked as unsuccessful scrub, and a technical staff member will research. If it is successful, the audit is placed in the platform operations queue. This queue is worked by platform operations team. The amount of time the operations team takes to review the audit is based on the automated “Audit of Audit” described earlier. In some cases, if the Audit of Audit is within an acceptable range, the audit can immediately be moved to the next stage, which is the Adjuster Queue. This is where the adjuster of the claim can review the audit, make adjustments as necessary and when ready, approve the audit. Once it is approved by the Adjuster it moves to the Insurance Queue where it will wait for an insurance claim handled to confirm receipt. Once receipt is confirmed the audit workflow is complete.

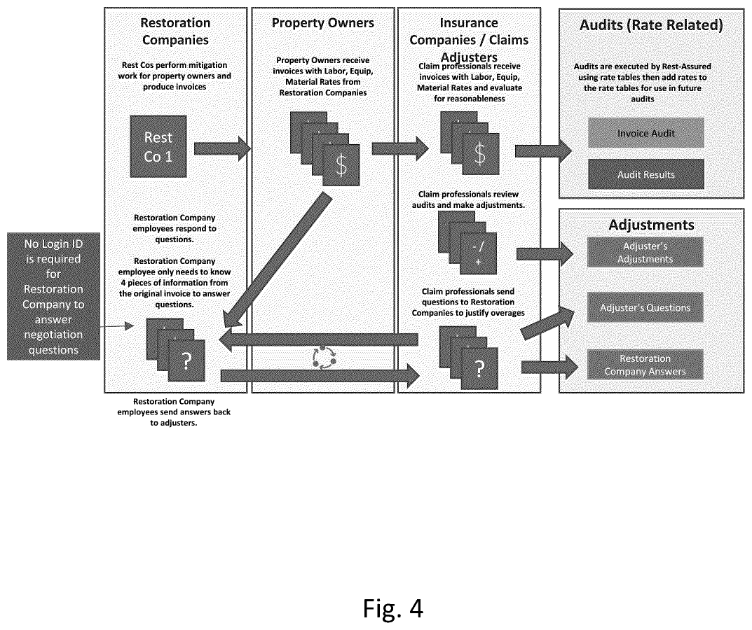

With reference now to FIG. 4, in one embodiment, a secure “no-login” auditor to restoration co. communication and negotiating service is provided. When an audit has been produced it is very important for the adjuster to communicate quickly and accurately any issues that require explanation to the restoration company. The platform provides the adjuster with a tool to communicate questions through a questionnaire. The adjuster creates a set of questions in in the app and sends a link to the contact at the restoration company. Since not all restoration companies will have a user id to the platform, it is critical that the link be accessible to anyone at the restoration company that has the answers to the questions. When the restoration company representative receives the email with the link they can click the link and see/answer the questions just by knowing four pieces of information that exist on the invoice. If that person does not know the answers, they can forward the e-mail with the link to anyone in the company with access to the invoice and they can answer the questions. This materially improves the speed and effectiveness of the negotiation process.

According to one embodiment, a secure “no-login” insurance company “confirm receipt” service is provided. When an audit has been completed and is delivered to the insurance company, it is important that the insurance company confirm receipt of the auditor's report. This documents clearly when the audit was delivered and when the insurance company received it. The platform provides the adjuster with a tool to communicate the audit to the insurance company by sending an attached PDF and a link to the insurance contact. Since not all insurance company claim handlers will have a user id to the platform, it is critical that the link be accessible to anyone at the insurance company that needs to see the report. When the claims handler clicks the link, they can easily click a “confirm receipt” button.

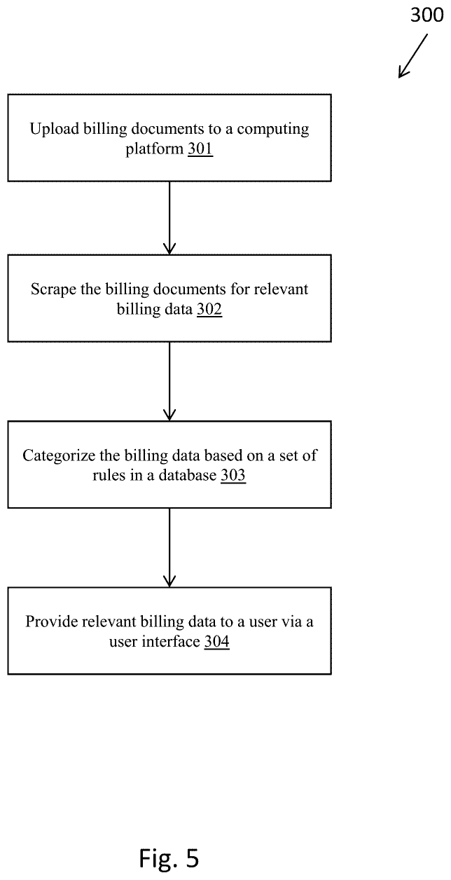

Referring now to FIG. 5, shown is a flowchart for an exemplary method 300 for auditing restoration bills according to one aspect of the present invention. In one embodiment, method 300 comprises the steps of 301 uploading billing documents to a software, 302 scraping the billing documents for relevant billing data, 303 categorizing the billing data based on a set of rules in a database, and 304 providing the relevant billing data to a user via a user interface.

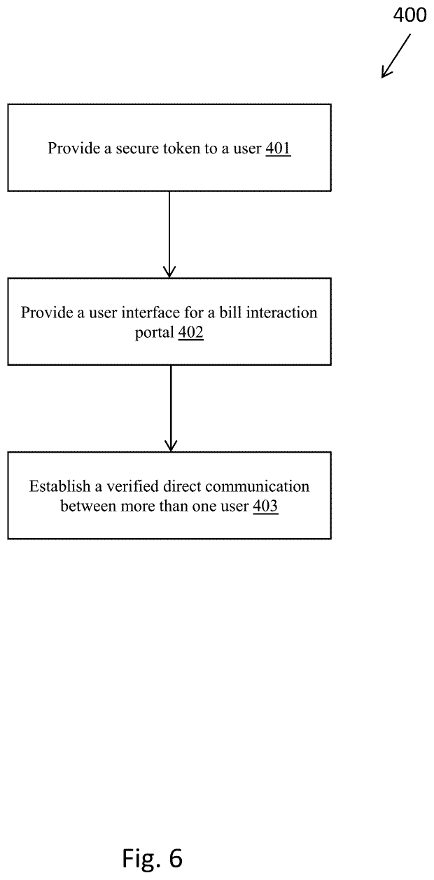

Referring now to FIG. 6, shown is a flowchart for an exemplary method 400 for authenticating a bill interaction portal according to one aspect of the present invention. In one embodiment, method 400 comprises the steps of 401 providing a secure token to a user, 402 providing a user interface for a bill interaction portal, and 403 establishing a verified direct communication between more than one user.

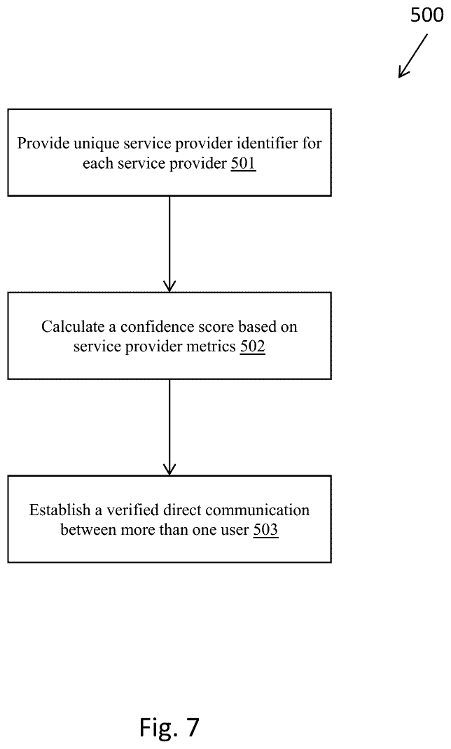

Referring now to FIG. 7, shown is a flowchart for an exemplary method 500 for generating service provider confidence score according to one aspect of the present invention. In one embodiment, method 500 comprises the steps of 501 providing a unique service provider identifier for each service provider; and 502 calculating a confidence score based on service provider metrics.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A computer-implemented method for peer-based remediation invoice auditing, the computer-implemented method comprising:
generating a first plurality of rate data by scraping rate data from a first invoice;
first classifying the first plurality of rate data based on identifying rate data types in the first plurality of rate data;
first populating a plurality of rate tables with the first plurality of rate data based on the rate data types in the first plurality of rate data, wherein each of the plurality of rate tables are populated with rate data from previously scraped invoices and each of the plurality of rate tables tracks a different type of rate data;
first auditing the invoice based on comparing a plurality of values generated from data in each of the plurality of rate tables; and
generating first audit result data based on the first auditing.

2. The computer-implemented method of claim 1, wherein the plurality of rate tables comprises at least one of a labor rate table, an equipment rate table and a materials rate table.

3. The computer-implemented method of claim 1 further comprising:
second generating a second plurality of rate data by scraping rate data from a second invoice;
second classifying the second plurality of rate data based on identifying rate data types in the second plurality of rate data;
second populating the plurality of rate tables with the second plurality of rate data based on the rate data types in the second plurality of rate data;
second auditing the second invoice based on second comparing a second plurality of values generated from second data in each of the plurality of rate tables, the second data including the rate data from previously scraped invoices and the first plurality of rate data from the first invoice; and
generating second audit result data based on the second auditing.

4. The computer-implemented method of claim 1, wherein the second data includes rate data from a third invoice scraped after the first auditing and before the second auditing.

5. The computer-implemented method of claim 1, wherein the first audit result data is further based on at least one rule variable updated in real time.

6. The computer-implemented method of claim 1 further comprising:
generating a benchmark audit of the first audit result and flagging the first audit if the benchmark audit is above a benchmark threshold.

7. The computer-implemented method of claim 6, wherein the benchmark threshold value is based on at least one of invoice total, total amount of issues, total amount of labor issues, total amount of equipment issues and total amount of material issues.

8. A system for peer-based remediation invoice auditing comprising:
a computer comprising a storage device comprising:
a database management system; and
computer-readable program code including steps for:
generating a first plurality of rate data by scraping rate data from a first invoice,
first classifying the first plurality of rate data based on identifying rate data types in the first plurality of rate data,
first populating a plurality of rate tables with the first plurality of rate data based on the rate data types in the first plurality of rate data, wherein each of the plurality of rate tables are populated with rate data from previously scraped invoices and each of the plurality of rate tables tracks a different type of rate data,
auditing the invoice based on comparing a plurality of values generated from data in each of the plurality of rate tables, and
generating first audit result data based on the auditing.

9. The system of claim 8, wherein the plurality of rate tables comprises at least one of a labor rate table, an equipment rate table and a materials rate table.

10. The system of claim 8, wherein the computer-readable program code further includes steps for:
second generating a second plurality of rate data by scraping rate data from a second invoice;
second classifying the second plurality of rate data based on identifying rate data types in the second plurality of rate data;
second populating the plurality of rate tables with the second plurality of rate data based on the rate data types in the second plurality of rate data;
second auditing the second invoice based on second comparing a second plurality of values generated from second data in each of the plurality of rate tables, the second data including the rate data from previously scraped invoices and the first plurality of rate data from the first invoice; and
generating second audit result data based on the second auditing.

11. The system of claim 8, wherein the second data includes rate data from a third invoice scraped after the first auditing and before the second auditing.

12. The system of claim 8, wherein the first audit result data is further based on at least one rule variable updated in real time.

13. The system of claim 8, wherein the computer-readable program code further includes steps for:
generating a benchmark audit of the first audit result and flagging the first audit if the benchmark audit is above a benchmark threshold.

14. The computer-implemented method of claim 13, wherein the benchmark threshold value is based on at least one of invoice total, total amount of issues, total amount of labor issues, total amount of equipment issues and total amount of material issues.

15-24. (canceled)
